(19) United States
(12) Patent Application Publication
(10) Pub. No.: US 2007/0121004 A1
(43) Pub. Date: May 31, 2007

(54) System and method for caching teletext

(75) Inventor: Taras M. Telyuk, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/572,837

(22) PCT Filed: Sep. 21, 2004
(86) PCT No.: PCT/IB04/51818

§ 371 Date: Mar. 21, 2006

(30) Foreign Application Priority Data
Sep. 23, 2003 (US) 60/505,233

(51) Int. Cl. H04N 11/00

(52) U.S. Cl. 348/468

(57) ABSTRACT

A teletext memory arrangement is organized as three memory sections, a first memory section (sequential memory 6a), a second memory section (sub-page memory 6b), and a third memory section (pipeline memory 6c). The sub-page memory (6b) and the sequential memory (6a) are dynamically dependent in the sense that whenever it is determined that the number of sub-pages of a user requested page N is less than the number of memory storage positions that make up the sub-page memory (6b), the unused memory storage positions of the sub-page memory (6b) are used to store higher order pages of the requested page N, thereby serving as a dynamic extension of the sequential memory. The third memory section (pipeline memory 6c) is used to store the K most recently requested teletext pages (the viewing history). The viewing history is maintained in a non-volatile memory (9) which is communicatively coupled to the teletext memory. When the TV set is powered on (or another TV channel is selected) the teletext decoder downloads those pages which correspond to the page numbers stored in the non-volatile memory (9).

The present invention relates generally to teletext decoders, and more specifically to a teletext decoder memory arrangement and method for using the same.

Teletext is an ancillary service of television channels designed for the transmission of written information as a complement to video information. This written information takes the form of pages that are broadcast one after the other, and the entire set of pages of the teletext program is broadcast cyclically. Each page has about 25 rows of 50 to 60 characters. The corresponding data are transmitted line by line, with the contents of a line being transmitted in one or more data packets.

Teletext broadcasting provides a simultaneous and repeated variety of programs by multiplexing text data and other information onto a single TV broadcasting channel. Teletext programming may include, for example, news, weather forecasts, TV program guides, leisure-related things, sports, culture, and stock exchange information to viewers.

A full teletext program of a television channel comprises, for example, 500 pages that are associated, as the case may be, to form logic sets known as magazines. Each magazine comprising a variable number of teletext pages. For example, the television station may propose four magazines whose themes are, respectively, sports, finance, international news and weather. In practice, each magazine is laconical and typically occupies not more than 3-6 sequential pages.

Typically, an end user checks the same teletext pages looking for new (updated) information. For example, an end user interested in sports may repeatedly check the sports magazine looking for updated scores and game results. The total time to broadcast a teletext program is about 50 seconds and all the teletext pages are broadcast in cycles. In other words, one page is broadcast approximately every 50 seconds. This enables the television station to very regularly update the information content of its pages or to create animation effects.

Depending upon the broadcaster, the magazines may be differently organized. One approach is to insert the subject matter (magazine) into a few sequential pages of teletext, i.e., pages N, N+1, N+2, . . . N+J. Another approach is to insert the subject matter into a set of sub-pages of a current page N, i.e., N₁, N₂, N₃, N₄. In this case, all of the sub-pages of page N are broadcast sequentially in a transmission cycle. After expiry of a complete transmission cycle, all of the sub-pages of page N are re-broadcast in a further transmission cycle. This process is repeated in successive transmission cycles, i.e., . . . , N₃, N₄, N ₁, N₂, N₃, N₄, N₁, N₂, . . . .

A drawback of television receivers having limited memory resources for storing teletext data is that an end user is required to wait each time for a download of a requested page or sub-page. This delay is inconvenient from the perspective of the user desiring streamlined functionality.

The present invention proposes a teletext memory arrangement and associated method of use which better utilizes the limited amount of teletext memory and overcomes the deficiencies of the prior art. Further, even in situations where memory availability is not an issue, the teletext memory arrangement and method of the invention provides a means for reducing the memory requirements without any appreciable performance reduction.

In general, the present invention is directed to a teletext memory arrangement. In one regard, the memory arrangement and associated method optimizes the use of a limited amount of teletext memory available in some teletext receivers. The memory arrangement of the invention can also be advantageously used to reduce the teletext memory requirements of more sophisticated teletext receivers having a large amount of memory.

According to an aspect of the present invention, a teletext memory arrangement of the invention is preferably organized as three memory sections, a first memory section (sequential memory), a second memory section (sub-page memory), and a third memory section (pipeline memory). The sequential memory is configured to store higher order pages of a requested page N, i.e., N+1, N+2, . . . , N+J. The sub-page memory is configured to store the multiple sub-pages of the requested page N, i.e., where N is comprised of N₁, N₂, N₃, N₄. The pipeline memory is made up of “K” storage positions and stores the “K” most recently requested teletext pages.

According to another aspect of the invention, the sub-page memory and sequential memory are dynamically dependent upon each other. In other words, in those cases where the number of sub-pages of a requested page to be stored is less than the number of storage positions of the sub-page memory, the unused storage positions of the sub-page memory are used to store sequentially higher order pages of the requested page. In this manner, a portion of the sub-page memory serves as an extension of the sequential memory. As such, the additional storage capacity of the sequential memory is dynamically dependent upon the excess storage availability of the sub-page memory. Excess storage capacity of the sub-page memory may arise in certain cases because, the number of sub-pages of a requested page to be stored is dependent upon the data organization (whether data is stored as sequential pages or as multiple sub-pages). Also, in the case where a page is stored as multiple sub-pages, the number of sub-pages may vary with each page.

The third memory section of the three part teletext memory arrangement, i.e., the pipeline memory, comprises “K” storage positions and is configured to store the “K” most recently requested teletext pages. The page numbers of the “K+1” most recently requested teletext pages are stored in a non-volatile memory in communication with the third memory section.

The foregoing features of the present invention will become more readily apparent and may be understood by referring to the following detailed description of an illustrative embodiment of the present invention, taken in conjunction with the accompanying drawings, where:

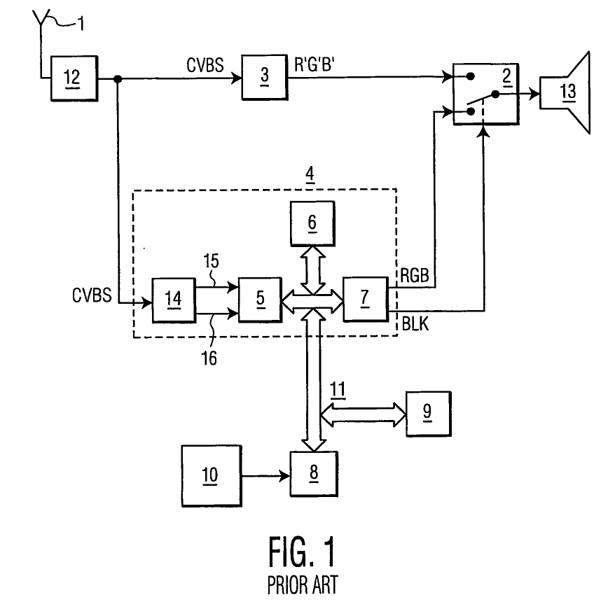

FIG. 1 is an illustration of the general structure of a television receiver according to the prior art;

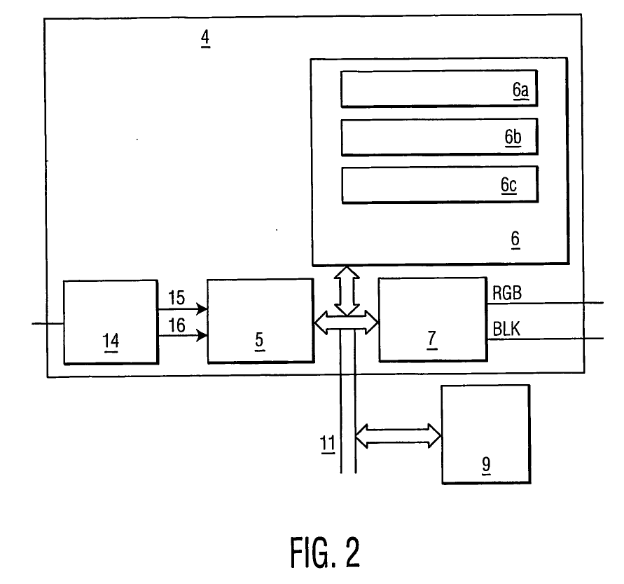

FIG. 2 is an illustration of the teletext decoder of FIG. 1 according to an embodiment of the invention;

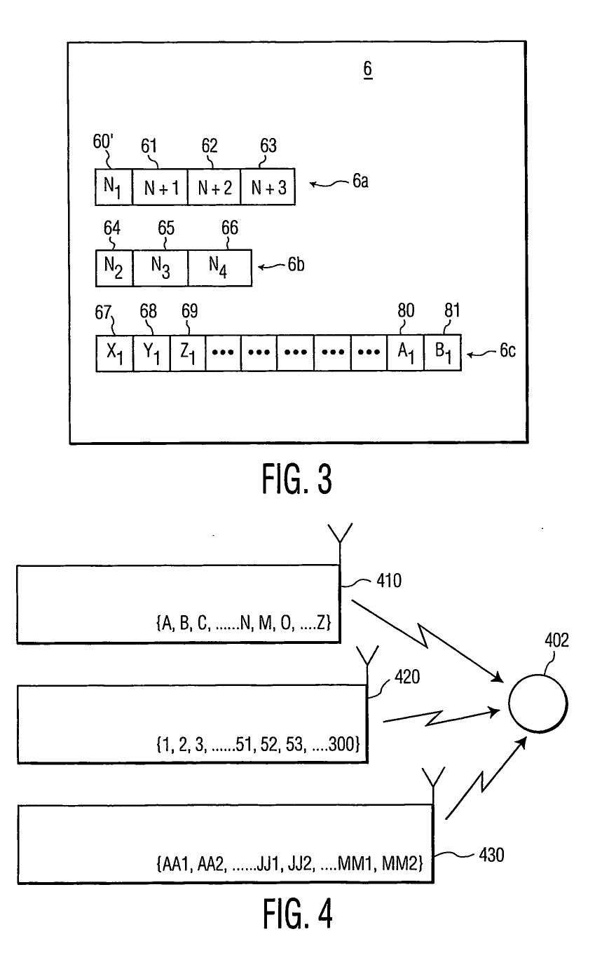

FIG. 3 is a more detailed illustration of the teletext memory portion of the text decoder decoder of FIG. 2 according to an embodiment of the invention;

FIG. 4 illustrates a high level diagram of a plurality of broadcast stations each transmitting a unique set of teletext pages according to the prior art;

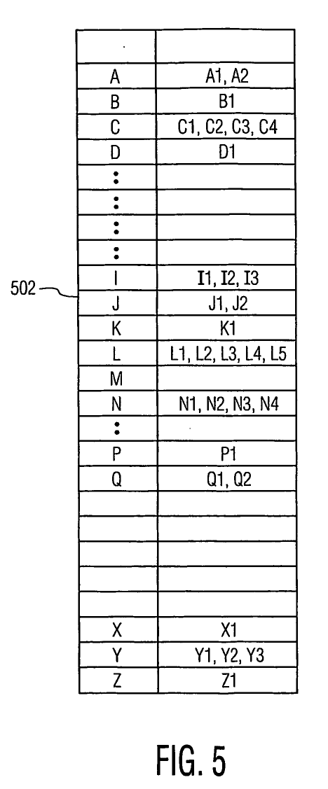

FIG. 5 is an exemplary illustration of the teletext pages which may be transmitted over a typical broadcast channel from one broadcaster of FIG. 4;

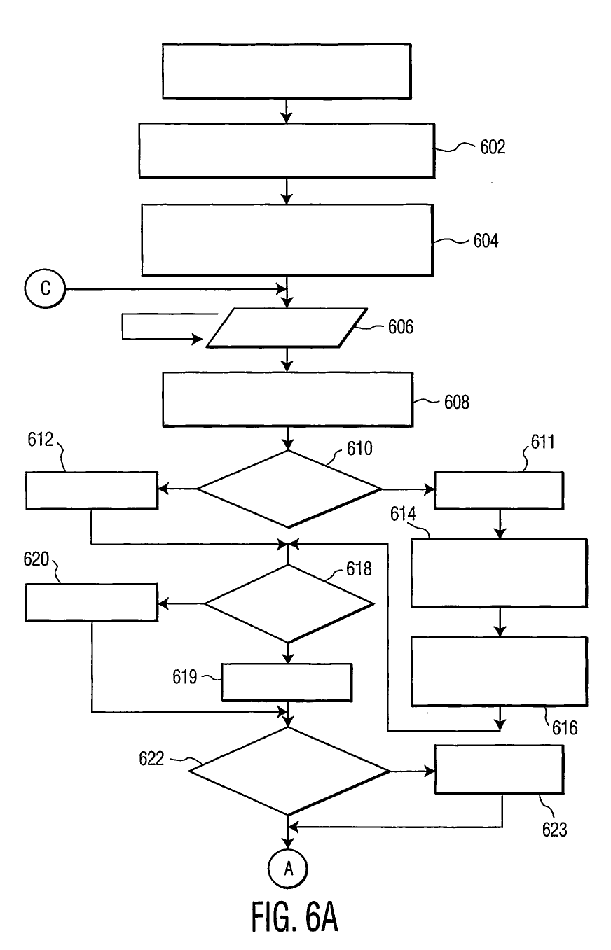

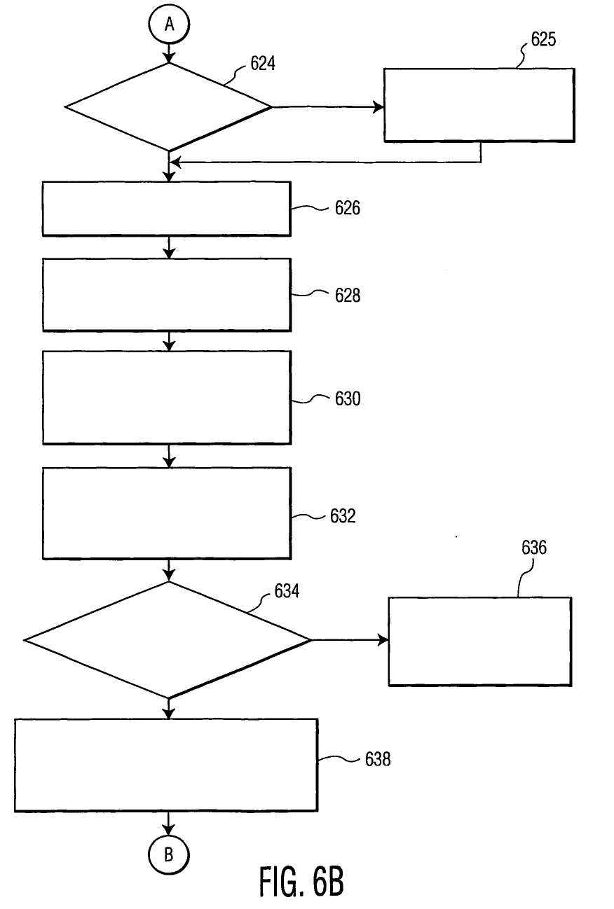

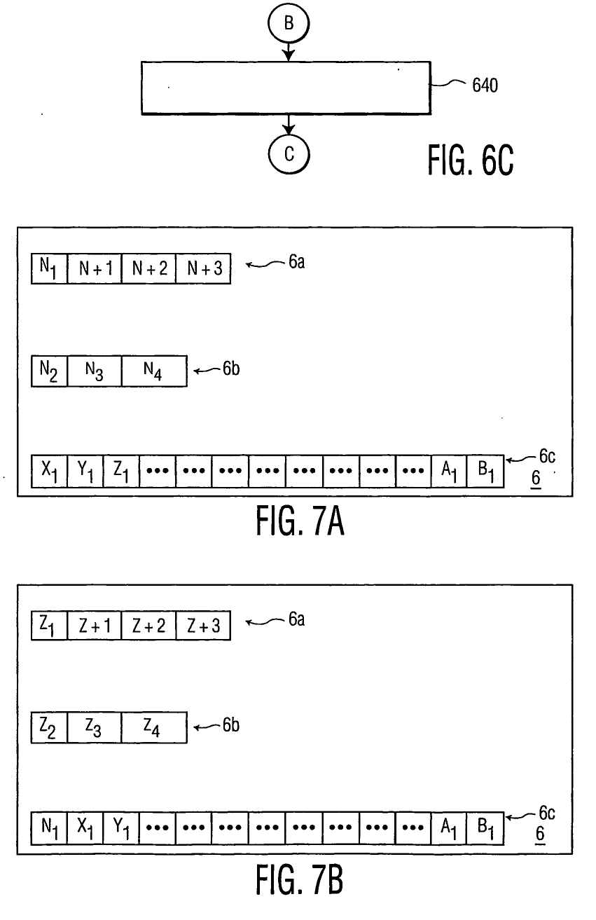

FIG. 6 is a flow diagram illustrating a method for smartly caching teletext pages according to one embodiment of the invention; and

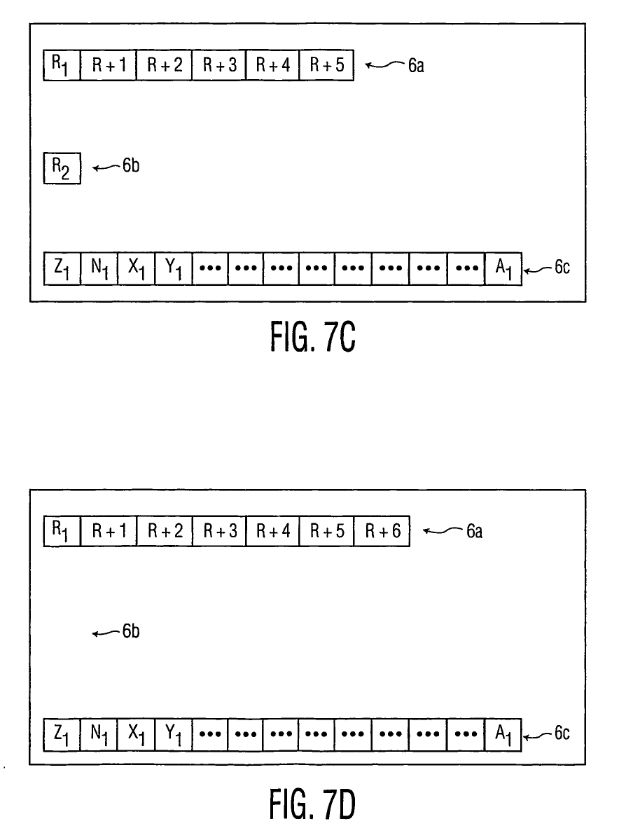

FIGS. 7a-d are exemplary illustrations of snapshot views of the teletext and pipeline memories of the invention according to one embodiment of the invention.

In the following detailed description of the present invention, numerous specific details are set forth in order to provide a thorough invention may be practiced without these specific details. In some instances, well-known structures and devices are shown in block diagram form, rather than in detail, in order to avoid obscuring the present invention.

FIG. 1 shows the general structure of a television receiver according to the prior art. The transmitter signals received at an antenna 1 are applied to a conventional tuning and demodulation circuit 12. The obtained composite video signal CVBS of the selected television program is simultaneously applied to a video signal-processing circuit 3 and to a teletext decoder 4. In a normal television operating state of the receiver, the elementary color signals R′G′B′ generated by video signal-processing circuit 3 are applied to a display screen 13 via a selector 2 in order that the user can watch the received television program. In a teletext operating state, which can be called by the user, the elementary color signals RGB of teletext decoder 4 are displayed via the switch 2. Operating instructions given by the user are generated in control TV interface unit 10 and applied to a control circuit 8. Teletext decoder 4 is connected to this control circuit 8 by means of a command bus 11.

Teletext decoder 4 comprises clipping circuit 14 which receives the composite video signal CVBS and generates a digital teletext data signal 15 as a first output and an associated clock signal 16 as a second output. The two outputs are supplied as respective inputs to acquisition circuit 5 which captures a set of selected teletext pages. The teletext pages to be selected are stored in teletext memory 6 under the control of control circuit 8 via command bus 11. Teletext memory 6 stores the captured teletext pages, each of which may be individually displayed. The teletext pages to be displayed are processed by display circuit 7 which is adapted to generate a blanking signal for operating switch 2.

FIG. 1 also shows a pipelined non-volatile memory 9, connected to the command bus 11, which stores the page numbers of the last “K+1” teletext pages viewed by a user. It is to be noted that in FIG. 1, the structure of the television receiver including the teletext decoder is shown functionally and that there are various possibilities for its actual realization.

FIG. 2 is a more detailed illustration of the teletext decoder 4 of FIG. 1 including a memory arrangement of a teletext decoder page memory 6 according to one embodiment of the invention. The novel teletext decoder page memory 6 is shown to be arranged as three memory sections. A first memory section, referred to hereafter as a sequential memory 6a, a second memory section referred to hereafter as a sub-page memory 6b and a third memory section, referred to hereafter as a pipeline memory 6c. FIG. 2 also shows a non-volatile memory section 9, which is used together with the sequential memory 6a and the pipeline memory 6c for storing page numbers associated with the data stored in the sequential 6a and pipeline memory 6c.

FIG. 3 is one embodiment of the teletext memory 6 of the teletext decoder of FIG. 2. FIG. 3 shows a sequential memory 6a comprised of 4 storage cells 60-63, a sub-page memory 6b comprised of 3 storage positions 64-66 and a pipeline memory 6c comprised of 13 storage positions 67-81. It is to be appreciated that other embodiments may have fewer or greater number of storage positions. One preferred memory arrangement is a configuration wherein the sequential memory 6a includes substantially from 1 to 7 storage positions and the sub-page memory 6b is configured to include substantially from 0 to 5 storage positions.

FIG. 4 illustrates a plurality of exemplary broadcast stations, e.g., broadcast stations “XYZ” 410, “ABC” 420, “EDP” 430, each transmitting a unique set of teletext pages as is conventional. The user 402 has the option of selecting any one of the available broadcast stations 410, 420, 430 at any point in time and further choosing any teletext page being transmitted by that station. The set of teletext pages being broadcast by one fictitious broadcaster are illustrated, by way of example, in FIG. 5.

FIG. 5 illustrates a set of teletext pages (left column) and their constituent sub-pages (right column) for broadcast from a fictitious broadcast channel, e.g., “XYZ” 410 of FIG. 4. As is conventional, the total number of pages of the service, e.g., pages A through Z, are broadcast in cycles, where a broadcasting cycle typically lasts approximately several tens of seconds.

In the operational flowchart of the method of the invention to follow, as described with reference to FIG. 6, reference is made throughout to preceding FIGS. 3-5, for ease of explanation of the principles of the invention.

FIG. 6 is a flowchart of one embodiment of the present invention of a method 600 for caching teletext pages in a teletext memory. In the acts to be described, it is presumed that a user is tuned to one of the broadcast channels illustrated in FIG. 4, e.g., broadcast channel “XYZ” 410 which provides those service pages illustrated in FIG. 5.

At Act 601: the process starts when either a user's television set (or equivalent viewing device) is powered “ON” or a new TV channel is selected by the user in a set which is currently being viewed.

At Act 602: the teletext decoder starts to capture downloaded pages and stores them into the sequential page memory 6a (at the first storage position) and the pipeline memory 6c, according to the pre-stored page numbers in the non-volatile memory 9. That is, the pre-stored page numbers determine which pages are to be downloaded into the sequential 6a and pipeline memory 6c. The teletext decoder also captures pages to be stored in other than the first storage position of memory 6a and to the sub-page memory 6b, generally in accordance with the method of the invention, in accordance with the acts described below (i.e., acts 618-626 and acts 632-640). It is to be appreciated that this act 602 describes the method of the invention for smartly caching teletext pages in a teletext decoder page memory, when a user is in a TV mode, as described at act 601. The method is otherwise performed at acts 618-626 and 632-640 below, with the distinction being that the user is presumed to have switched from the TV mode to the teletext mode (see act 604).

At Act 604: a user receiving broadcast channel “XYZ” 410 switches from television to teletext mode. In response, a default page or the last previously viewed teletext page is shown to the viewer. The last previously viewed page is identified by its associated page number stored in the first memory storage position of the non-volatile memory 9.

At Act 606: the process is idle, waiting for a user request for a teletext page. During this idle time, with each new loop (cycle) of broadcasted teletext pages A-Z of FIG. 5, those teletext pages which have already been captured and previously stored are updated in the teletext memory 6.

At Act 608: an end user makes a request to view a particular teletext page, e.g., page N 502 of broadcast channel XYZ 410.

At Act 610: determine whether the user requested page N 502 is already present in the pipeline memory 6c.

If it is determined that the requested page N 502 is already present in the pipeline memory 6c at act 610, then set findflag=1 (Act 611) and the process continues at act 614. Otherwise set findflag=0 (Act 612) and the process continues at act 618.

It is noted that whenever a requested page N is to be stored in the pipeline memory, it is actually the first sub-page N₁ of the page N that is stored.

At act 614: a first sub-page N₁ of the requested page N is removed from the pipeline memory 6c and placed into the first storage position of the sequential memory 6a. The first sub-page N₁ is also displayed to the user 402.

At act 616: all reference pages in positions preceding the requested page N are shifted by one storage position to the end of the pipelined memory 6c in FIFO like manner. Correspondingly, the page number associated with the requested page N is extracted from non-volatile memory 9 and all reference page numbers in storage positions preceding the page number of the requested page is shifted in the non-volatile memory 9 in FIFO like manner. Further, the page number associated with the first sub-page N₁ of the requested page N is placed into the first storage position of the non-volatile memory 9.

At act 618: determine whether the requested page N₁ includes multiple sub-pages. In the instant example, the requested page N consists of four sub-pages, i.e., N=N₁, N₂, N₃, N₄, as shown in FIG. 5.

If it is determined at act 618 that the requested page consists of multiple sub-pages, set the multiple sub-pages flag, multflag=1 (Act 619), otherwise set multflag=0 (Act 620).

At act 622: determine if findflag=0 and multflag=1 (i.e., if the requested page was not found in the pipeline memory and consists of multiple sub-pages).

If it is determined that act 622 is true, download all sub-pages N₁, N₂, N₃, N₄ of the requested page N from the currently selected broadcast channel 410 (act 623). Otherwise the process continues at act 624.

At act 624: determine if findflag=1 and multflag=1 (i.e., if the requested page was found in the pipeline memory and consists of multiple sub-pages).

If it is determined that act 624 is true, download the multiple sub-pages N₂, N₃ and N₄ of the requested page N with the exception of the first sub-page N₁ (act 625). Otherwise the process continues at act 626.

At act 626: the contents (storage positions) of the sequential memory 6a are cleared.

At act 628: the previously requested page is placed at the first storage position 621 of the pipeline memory 6c.

At act 630: the requested page N1 is stored in the first storage position 601 of the sequential memory 6a and the page number associated with the requested page is placed at the first storage position of the non-volatile memory 9.

At act 632: the sub-pages which comprise the requested page N₁ are stored in respective storage cells of the sub-page memory 6b. In the example shown, pages N₂, N₃ and N₄ are stored at storage positions 64-66, respectively.

At act 634, determine if the sub-page memory 6b has at least one available storage position. In other words, does the sub-page memory 6b have any excess storage availability.

If it is determined that act 634 is true, use the at least one available storage position of the sub-page memory to extend the storage capacity of the sequential memory 6a (act 636). That is, is it used to store further higher order sequential pages of the requested page N. In the present example, there is no excess storage capacity in the sub-page memory 6b. Otherwise, if it is determined that act 634 is false, the process continues at act 638.

At act 638: the sequential memory 6a stores those page numbers of teletext pages which follow the requested page in sequential order. In the example shown, sequential pages N+1, N+2, N+3 are shown stored at sequential memory storage positions 60-64, respectively.

At Act 640: the process loops back to act 606 awaiting a further request from the user for another teletext page.

It should be noted that the simplified flowchart depicted in FIG. 6 is exemplary of the method of the present invention. In that regard, the acts of such method may be executed in sequences other than those shown in FIG. 6, including the execution of one or more steps simultaneously.

FIG. 7 further illustrates, by way of example, a snapshot of how teletext information is stored in accordance with the memory arrangement and method of the invention.

Referring first to FIG. 7a, there is shown a snapshot of the teletext memory 6 at a point in time just after a user has requested to view page N. It is assumed that page N is comprised of 4 sub-pages, i.e., pages N₁, N₂, N₃ and N₄. In this case, the sequential memory 6a stores the first sub-page N1 and three pages which follow page N1 in sequential order, i.e., pages N+1, N+2, N+3. The sub-page memory 6b stores the sub-pages N₂, N₃ and N₄. The pipeline memory 6c stores 13 previously requested pages with page X1 being the most recently requested page prior to the current request for page N and page B being the least most recently requested page stored at the end of the pipeline memory 6c.

Referring now to FIG. 7b, there is shown a snapshot of the teletext memory 6 at a point in time just after a user has made a new request to view page Z. It is assumed in the example shown, that page Z is present in the pipeline memory 6c and consists of 4 sub-pages, i.e., Z₁, Z₂, Z₃ and Z₄. Responsive to the user request, page Z₁ is removed from the pipeline memory 6c, placed into the first position of sequential memory 6a and immediately shown to the end user. While the user is viewing page Z₁, sub-pages Z₂, Z₃ and Z₄ are downloaded into the subpages memory 6b. Also, sequentially higher order pages Z+1, Z+2 and Z+3 are downloaded into the sequential memory 6a. Reference to Z₁ in the pipe memory 6c is removed and all reference pages in the pipeline memory 6c in positions preceding Z₁, i.e., X₁ and Y₁ will be shifted one place to the right of the pipe in FIFO like manner. The corresponding numbers (page identifiers) are shifted one place to the right of the pipe in FIFO order in the non-volatile memory 9. Finally, N1, the previous user request, is placed at the beginning of the pipeline memory 6c, number of page Z is placed at the first position of non-volatile memory 9.

Referring now to FIG. 7c, there is shown a snapshot of the teletext memory 6 at a point in time just after a user has made a new request to view page R. It is assumed in the example shown, that page R is not present in the pipeline memory 6c and consists of 2 sub-pages, i.e., R₁, R₂. Responsive to the user request, page R₁ is downloaded to be shown to the viewer without delay. While the user is viewing page R₁, sub-page R₂ and higher order sequential pages, R+1, R+2, R+3, R+4 and R+5 are downloaded into the memory as they become available from the broadcast channel. Z₁, the previous user request, is placed at the beginning of the pipeline memory 6c with the pipeline shifting its existing contents one position to the right in FIFO order effectively removing reference to page B. All numbers placed in non-volatile memory 9 are shifted to the right of the pipe in FIFO like manner, number of page R is placed at the first position in non-volatile memory 9.

Referring now to FIG. 7d, there is shown a snapshot of the teletext memory 6 at a point in time just after a user has decided to switch to another TV channel, e.g., channel “EDP”. Teletext decoder starts immediately downloading and placing into pipe memory 6c pages with the numbers according to numbers which ate stored in 2, . . . , “K+1” positions of non-volatile memory. Given that the last request made on the previous channel, “XYZ”, was for page R (this page number is stored and is taken from the first position of non-volatile memory 9), upon switching stations, page R as constructed in accordance with channel “EDP” will be retrieved and displayed to the end user. Further, page R, which is assumed to be comprised of 6 sub-pages, will be stored in the memory. As shown in FIG. 7d, because page R in the new channel does not include multiple sub-pages, the entire sub-page memory 6b is dynamically linked to the sequential memory 6a and serves as an extension of the sequential memory 6a providing an additional 3 storage cells for storing further sequential pages, i.e., pages R+4, R+5 and R+6.

Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A teletext decoder page memory (6), comprising: a memory configuration including a first memory section (6a), a second memory section (6b) and a third memory section (6c), each of said first, second and third memory sections being comprised of a plurality of memory storage positions, the first memory section (6a) is used for storing a first subpage N₁ of a user requested page N and also for storing sequentially higher order pages (N+1, N+2, . . . , N+J) of said user requested page N, the second memory section (6b) is used primarily for storing sub-pages (N₂, N₃, . . . Nᵢ) of said user requested page N; and the third memory section (6c) for storing the K most recently requested teletext pages by the user;
wherein the second memory section (6b) may also be used for storing additional sequentially higher order pages (N+(J+1)), (N+(J+2)) of said requested page N when it is determined that the second memory section (6c) has at least one unused memory storage position available subsequent to storing said sub-pages (N₂, N₃, . . . Nᵢ) of said user requested page N.

2. The teletext decoder of claim 1, wherein said second memory section (6b) stores additional sequentially higher order pages (N+(J+1)), (N+(J+2)) of said requested page N which follow in sequential order from the highest sequentially higher order page stored in said first memory section (6a).

3. The teletext decoder of claim 1, wherein said second memory section (6b) stores additional sequentially higher order pages (N+(J+1)), (N+(J+2)) of said requested page N in direct proportion to the number of unused memory storage positions available.

4. The teletext decoder page memory of claim 1, wherein the first memory section (6a) is a sequential memory (6a) for storing the first subpage N of said requested page N and sequentially higher order pages (N+1, N+2, . . . , N+J)of said requested page N in one of a television mode and a teletext mode.

5. The teletext decoder page memory of claim 1, wherein the second memory section (6b) is a sub-page memory (6b) for storing the second through Nth sub-page of said requested page N and for storing sequentially further higher order pages (N+(J+1)), (N+(J+2)) of said requested page N, wherein said further higher order pages follow in sequential order from the highest order page stored in the sequential memory (6a).

6. The teletext decoder page memory of claim 1, further comprising: a non-volatile memory (9), the non-volatile memory (9) configured to store (K+1) page numbers, wherein said (K+1) page numbers include one of a page number of a last viewed teletext page and the page numbers of the K most recently requested teletext pages stored in the third memory section (6c).

7. The teletext decoder page memory of claim 6 wherein the page number of a last viewed teletext page is one of a page number of a last viewed page in a television mode and a page number of a currently viewed teletext page in a teletext mode.

8. A method for smartly caching teletext pages in a teletext decoder page memory comprised of at least a first memory section, a second memory section and a third memory section, the method comprising the acts of:
storing a first sub-page of a user requested page N in the first memory section (6a);
storing sequentially higher order pages (N+1, N+2, . . . N+J) of said user requested page N in the first memory section (6a);
storing sub-pages (N₂, N₃, N₄, . . . , Ni) of the user requested page N in a second memory section (6b);
determining if the second memory section (6b) has at least one unused memory storage position; and
using the at least one unused memory storage position of the second memory section (6b) to store additional higher order pages (N+(J+1), N+(J+2), . . . ) of said requested page N.

9. The method of claim 8, wherein the act of storing a first sub-page of a user requested page N in the first memory section (6a) further comprises the acts of:
purging the contents of the memory storage cells of the first memory section (6a);
determining if a first sub-page N₁ of the user requested page N is previously stored in the third memory section (6c);
if said determining act is true:
a) retrieving the first sub-page N₁ from the third memory section (6c);
b) storing the first sub-page N₁ in the first storage position of the first memory section (6a);
c) displaying the first sub-page N₁ to the user;
d) shifting all teletext pages preceding the first sub-page N₁ in the third memory section (6c) to the right in FIFO like manner; and
e) storing the page corresponding to a previous user request at the first memory storage position of the third memory section (6c);
if said determining act is not true downloading a first sub-page N₁ of the user requested page N.

10. The method of claim 8, further comprising the acts of:
shifting all page numbers preceding the page number of the requested page N to the right in a non-volatile memory (9) in FIFO like manner; and
storing the page number associated with the user requested page N in a first storage memory storage position of the non-volatile memory (9).

11. The method of claim 8, wherein the act of storing sub-pages of the user requested page in a second memory section (6b) further comprises the acts of:
determining if the user requested page N consists of multiple sub-pages (N₁, N₂, . . . , Nᵢ, Nᵢ₊₁); and
if said determining act is true, performing the act of downloading the multiple sub-pages (N₂, . . . , Ni, Nᵢ₊₁) of the requested page N.
